(19) United States
(12) Patent Application Publication
(10) Pub. No.: US 2023/0368627 A1
(43) Pub. Date: Nov. 16, 2023

(54) TRANSMITTING A SECURITY ALERT WHICH INDICATES A LOCATION IN A RECIPIENT'S BUILDING

(71) Applicant: SIGNIFY HOLDING B.V., EINDHOVEN (NL)

(72) Inventors: BERENT WILLEM MEERBEEK, VELDHOVEN (NL); PETER DEIXLER, ARLINGTON, MA (US)

(21) Appl. No.: 18/027,234

(22) PCT Filed: Sep. 16, 2021
(86) PCT No.: PCT/EP2021/075427

§ 371 Date: Mar. 20, 2023

Related U.S. Application Data
(60) Provisional application No. 63/081,520, filed on Sep. 22, 2020.

(30) Foreign Application Priority Data
Sep. 24, 2020 (EP) 20198072.9

(51) Int. Cl. G08B 7/06; G08B 13/08; G08B 25/00

(52) U.S. Cl. CPC G08B 7/064; G08B 13/08; G08B 25/005

(57) ABSTRACT

A system is configured to obtain detection data from one or more detector devices (31-36), detect a possible intruder in a first building (51) based on the detection data, determine a location (63) associated with the possible intruder based on the detection data, select a receiver (71) by comparing the location with multiple locations, and obtain building information associated with the receiver. This building information describes a second building (52). The system is further configured to determine, based on the building information and the location of the possible intruder, a location (68) in or around the second building from which the possible intruder is expected to be visible, and transmit a security alert to the receiver. The security alert comprises a request requesting the receiver or a user of the receiver to look at the first building from the location in or around the second building.

### FIELD OF THE INVENTION

The invention relates to a system for transmitting a security alert in response to detecting a possible intruder in a first building.

The invention further relates to a method of transmitting a security alert in response to detecting a possible intruder in a first building.

The invention also relates to a computer program product enabling a computer system to perform such a method.

### BACKGROUND OF THE INVENTION

In the past, consumers that were interested in a home security system subscribed to a security service offered by a security company. The security company would typically provide a home security system comprising one or more motion sensors, one or more door sensors and/or one or more window sensors and would send someone to the home when a possible intruder would be detected (e.g. after calling the homeowner first). Furthermore, these home security systems might switch on flashing lights when a possible intruder would be detected to alert neighbors and passersby.

Nowadays, camera-based home security systems for consumers are readily available. While in a professional system, typically someone from a security company monitors the video feed, consumers normally monitor the video feed themselves, e.g. in response to a motion detection alert. This has resulted in an increasing popularity of home security systems.

Such a camera-based home security system can also be used to help neighbors monitor their homes. For example, US 2017/280112 discloses that an owner/user of an A/V doorbell is able to share video footage recorded by the A/V doorbell with one or more other owners/users of other A/V doorbells. The determination of which users will receive a notification of the shared video footage is based on the relative locations of the A/V doorbells associated with the different users. A drawback of this method is that the shared video footage is often not useful for determining or confirming whether there is an intruder or not.

### SUMMARY OF THE INVENTION

It is a first object of the invention to provide a system, which can be used to help determine whether a detected possible intruder is indeed an intruder or not.

It is a second object of the invention to provide a method, which helps determine whether a detected possible intruder is indeed an intruder or not.

In a first aspect of the invention, a system for transmitting a security alert in response to detecting a possible intruder in a first building comprises at least one input interface, at least one output interface, and at least one processor configured to obtain, via said at least one input interface, detection data from one or more detector devices, detect said possible intruder in said first building based on said detection data, determine a location associated with said possible intruder based on said detection data, select a receiver from a plurality of receivers by comparing said location associated with said possible intruder with a plurality of locations associated with said plurality of receivers, obtain building information associated with said receiver, said building information describing a second building, determine, based on said building information and said location of said possible intruder, a location in or around said second building from which said possible intruder is expected to be visible, and transmit, via said at least one output interface, a security alert to said receiver, said security alert comprising location information indicative of said location in or around said second building and a request requesting said receiver or a user of said receiver to look at said first building from said location in or around said second building.

Instead of letting a home security system share information with neighbors that might or might not help these neighbors determine whether there is an intruder or not, which they may not be aware of yet, this system allows the owner/user of a home security system to get help from his neighbors when a possible intruder has been detected. For example, when presence has been detected, it is not always easy to understand directly from this event whether there is a security threat. It might be the cat, the cleaning lady, or something else than a burglar that can explain the detected presence. This is especially the case if the detection system comprises the wireless lighting infrastructure performing RF-based sensing. In this case, there may not be any dedicated sensing hardware deployed and false positives may be more common than with traditional multi-technology occupancy sensors (e.g. PIR+ultrasonic sensors), which are purposefully placed at the perfect sensing locations for home security.

With this system, no cameras are required, and no camera images need to be transmitted. It is sufficient to provide meaningful context information to one or more neighbors, allowing these neighbors to inspect the house where the possible intruder has been detected from their own homes. Instead of (just) providing information where the possible intruder has been detected, the security alert gives instructions from which location to specifically look for signs of an intruder.

For example, the security alert may ask a neighbor: “please look through your north-facing window in your living room”. Hence, the instruction tells the neighbor where to look from his/her perspective. This is more useful than telling the neighbor to look at the TV room of the house where the possible intruder has been detected, as the neighbor may not know where the TV room is within this house. The neighbor can then interpret what evidence he sees from the north facing window and may be able to report this to the system. For example, the neighbor may be able to report that he does not see a window or door which has been opened forcefully. The system may then interpret what the neighbor doing the inspection has reported depending on his location (e.g. the observation was made while staying inside and looking out of the north facing window to the TV room). For example, if no one forcefully opened the door, the owner/renter of the house may have fallen.

The system may be able to detect said possible intruder not just in said first building, but also around said first building, e.g. in the garden, based on said detection data. The selected receiver may be an (individual) person or a device, e.g. a display of a smart home system. This device may be associated with a household ID, street address, or device ID, for example. A security alert transmitted to a person is typically transmitted to a device associated with this person and then displayed or output via speech by this device.

Said at least one processor may be configured to select a further receiver from said plurality of receivers based on said comparison of said location associated with said possible intruder with said plurality of locations associated with said plurality of receivers, obtain further building information associated with said further receiver, said further building information describing a third building, determine, based on said further building information and said location of said possible intruder, a location in or around said third building from which said possible intruder is expected to be visible, and transmit, via said at least one output interface, a further security alert to said further receiver, said further security alert comprising further location information indicative of said location in or around said third building and a further request
requesting said further receiver or a user of said further receiver to look at said first building from said location in or around said third building. The location in or around the second building and/or the location in or around the third building may be a living room, bedroom, kitchen, bathroom, hallway, porch, garden, or balcony, for example.

Security alerts may be transmitted to multiple receivers, e.g. if a room is visible to multiple neighbors or if a possible intruder is detected in multiple rooms. Normally, each neighbor has a different visibility to a specific zone of the house where the detection has occurred. Therefore, each neighbor gets a different relative instruction what to look for based on his relative position and line of sight. This instruction is based on where the possible intruder has been detected in the house with the detection system and building information of the neighbor's house.

The building information may be floorplan information, e.g. from BIM systems, or maps generated from camera images (e.g. 3D scans, Google Maps). For example, based on publicly accessible data (e.g. satellite images, floorplans of houses from the town), the system may build a model of the neighborhood and decide what neighbor window can see what of the other house. The security alert gives an indication where the neighbor should go to in his home to get the right view.

Said at least one processor may be configured to select a lighting device from a plurality of lighting devices based on said location of said potential intruder and control, via said at least one output interface, said lighting device to render a (e.g. dynamic) light effect, and wherein said request requests said receiver or said user of said receiver to look in the direction of said (dynamic) light effect. This makes it easier for the person to know where to look. For example, a neighbor may be asked to look for the flashing green light.

Said at least one processor may be configured to determine a direction from said location in said second to building to said location of said possible intruder and include said direction in said security alert, and wherein said request requests said receiver or said user of said receiver to look in said direction. This is beneficial, for example, if it is not possible to control a lighting device in the first building or if it is important not to make the possible intruder aware that he has been detected. An instruction like “look at the TV room” is often not useful, as the recipient of the security alert often does not know whether the TV room in his neighbor's house is. Requesting a person too look in a certain direction does not have this drawback.

Said at least one processor may be configured to select said receiver from said plurality of receivers by selecting a person which has been determined to be at home. This ensures that persons that are not able to inspect the first building from their own building right now do not receive useless security alerts. If the security alert is transmitted to a device that is used by an entire family, it is preferably not transmitted to this device when only the person's children are at home. When a neighbor is not at home at first, a security alert may be transmitted to him when he gets back home, as soon as he has been determined to be at home.

Said at least one processor may be configured to select said receiver from said plurality of receivers based on activities currently being performed by said plurality of receivers. An activity performed by a person may be sleeping, showering, or reading, for example. In the latter case, the person may be regarded as easiest to be approached for inspecting the first building. An activity might also be a digital activity detected on a device that is used for receiving notifications such as a smart phone. If a user of said device is busy making a phone call, reading an e-book, or browsing a website, the person may be regarded as less approachable to inspect the first building.

Said at least one processor may be configured to select said receiver from said plurality of receivers by selecting a person which is designated as a friend and/or is associated with a previous security alert transmitted on behalf of said person and/or has signed up for receiving security alerts and/or is designated as a reliable inspector. For example, the system may be configured not to transmit security alerts to all neighbors with a good view, but at first only transmit a security alert to the neighbor who is a friend of the home owner or the specific neighbor for whom the home owner himself earlier has performed a similar type of inspection task favor. Security alerts may be transmitted to different neighbors depending on their opt-in level. For instance, a first neighbor may be prepared to look out of his window but not to go to the house, a second neighbor may be prepared to look out of his window and go to the house and a third neighbor may not be prepared to do either.

Said at least one processor may be configured to transmit, via said at least one output interface, a further security alert to said receiver at a later time, said further security alert comprising a further request requesting said receiver or a user of said receiver to go to said first building. For example, the system may first ask a neighbor to look through a specific window and then, after he has reported that he has not seen anything, ask the neighbor an hour later ask to check the door of the house, as the risk of a physical inspection is lower an hour later.

Said at least one processor may be configured to determine said location associated with said possible intruder based on a location of at least one of said one or more detector devices. For example, if a possible intruder is detected with two or three RF-based sensing detectors, e.g. lighting devices, located in the TV room, the TV room may be determined to be the location of the possible intruder.

Said at least one processor may be configured to determine a risk level based on said detection data and include said risk level in said security alert. The risk level provides an estimation of the risk that the person asked to do the inspection faces. The risk level may indicate whether the security alert is associated with a minor risk (e.g. an elderly person may have fallen in backyard according to RF-based sensing) or a risky burglar suspicion. For example, said at least one processor may be configured to determine from said detection data whether a door or window was forcefully opened and determine said risk level based on whether said door or window was forcefully opened.

Said at least one processor may be configured to transmit, via said at least one output interface, a message to another receiver, said other receiver being associated with said first building, said message requesting approval for transmitting said security alert to said receiver, and if said approval has been received from said other receiver, transmit said security alert to said receiver. Thus, there may first be a check with the owner/renter of the house whether the system should transmit a security alert to a certain person or to any person before transmitting the security alert(s).

In a second aspect of the invention, a method of transmitting a security alert in response to detecting a possible intruder in a first building comprises obtaining detection data from one or more detector devices, detecting said possible intruder in said first building based on said detection data, determining a location associated with said possible intruder based on said detection data, selecting a receiver from a plurality of receivers by comparing said location associated with said possible intruder with a plurality of locations associated with said plurality of receivers, obtaining building information associated with said receiver, said building information describing a second building, determining, based on said building information and said location of said possible intruder, a location in or around said second building from which said possible intruder is expected to be visible, and transmitting a security alert to said receiver, said security alert comprising location information indicative of said location in or around said second building and a request requesting said receiver or a user of said receiver to look at said first building from said location in or around said second building. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for transmitting a security alert in response to detecting a possible intruder in a first building.

The executable operations comprise obtaining detection data from one or more detector devices, detecting said possible intruder in said first building based on said detection data, determining a location associated with said possible intruder based on said detection data, selecting a receiver from a plurality of receivers by comparing said location associated with said possible intruder with a plurality of locations associated with said plurality of receivers, obtaining building information associated with said receiver, said building information describing a second building, determining, based on said building information and said location of said possible intruder, a location in or around said second building from which said possible intruder is expected to be visible, and transmitting a security alert to said receiver, said security alert comprising location information indicative of said location in or around said second building and a request requesting said receiver or a user of said receiver to look at said first building from said location in or around said second building.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 depicts partial floorplans of three buildings of which one comprises multiple detector devices;

FIG. 2 is a block diagram of an embodiment of the system;

FIG. 3 is a flow diagram of a first embodiment of the method;

FIG. 4 is a flow diagram of a second embodiment of the method;

FIG. 5 shows a first example of a displayed security alert;

FIG. 6 shows a second example of a displayed security alert;

FIG. 7 shows a third example of a displayed security alert;

FIG. 8 is a flow diagram of a third embodiment of the method; and

FIG. 9 is a block diagram of an exemplary data processing system for performing the method of the invention.

Corresponding elements in the drawings are denoted by the same reference numeral.

### DETAILED DESCRIPTION OF THE EMBODIMENTS

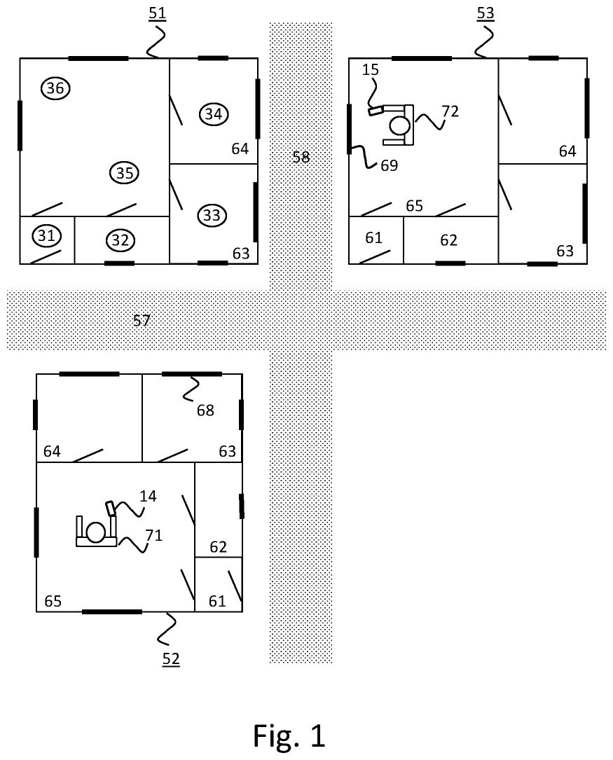

FIG. 1 depicts partial floorplans of three buildings of which one comprises multiple detector devices. Each of the houses 51-53 comprises a hallway 61, a bathroom 62, two bedrooms 63 and 64 and a living room/kitchen 65. Houses 51 and 52 are separated by a road 57 and houses 51 and 53 are separated by a road 58. Six detector devices 31-36 have been installed in house 51. These detector devices 31-36 may be lighting devices that perform RF-based sensing, for example.

If a possible intruder is detected in bedroom 64 of house 51, then this intruder may be visible from the window 69 of the house 53 by a person 72. A security alert may then be transmitted to the mobile device 15 of person 72. If a possible intruder is detected in bedroom 63 of house 51, then this intruder may be visible from the window 69 of the house 53 by person 72 and from the window 68 of the house 52 by person 71. A security alert may then be transmitted to the mobile device 15 of person 72 and the mobile device 14 of person 71.

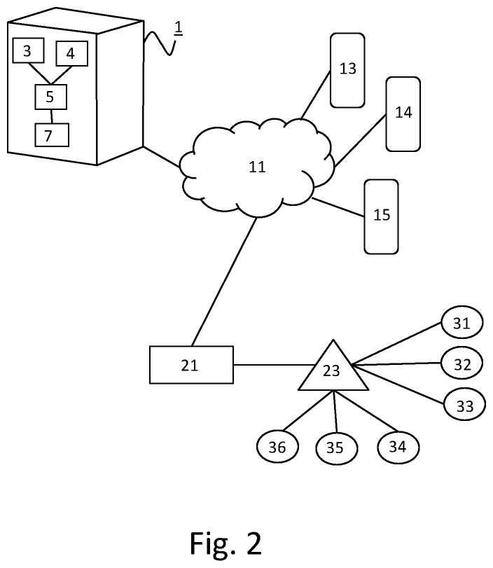

FIG. 2 shows an embodiment of the system for transmitting a security alert in response to detecting a possible intruder in a first building. In this first embodiment, the system is a computer 1. The computer 1 is connected to the Internet 11 and acts as a server. Six detector devices 31-36 have been installed in the first building, e.g. house 51 of FIG. 1. In the example of FIG. 2, the six detector devices 31-36 communicate with the computer 1 via a controller 23, e.g. a Hue bridge, and a wireless Internet access point 21.

The computer 1 comprises a receiver 3, a transmitter 4, a processor 5, and storage means 7. The processor 5 is configured to obtain, via the receiver 3, detection data from the detector devices 31-36, detect the possible intruder in the first building based on the detection data, and determine a location associated with the possible intruder based on the detection data. The processor 5 may be configured to determine the location associated with the possible intruder based on a location of at least one of the one or more detector devices 31-36, for example.

The processor 5 is further configured to select a person, e.g. person 71 and/or person 72 of FIG. 1, from a plurality of persons by comparing the location associated with the possible intruder with a plurality of locations associated with the plurality of persons and obtain building information associated with the person. The building information describes a second building.

The processor 5 is further configured to determine, based on the building information and the location of the possible intruder, a location in or around the second building from which the possible intruder is expected to be visible, and transmit, via the transmitter 4, a security alert to the person. The security alert comprises location information indicative of the location in or around the second building and a request requesting the person to look at the first building from the location in or around the second building. The security alert may be transmitted to the selected person by transmitting it to a mobile device of the selected person, e.g. mobile device 14 and/or mobile device 15, or to a device (e.g. smart speaker) near the selected person, for example.

The processor 5 may be further configured to transmit, via the transmitter 4, a message to another person who is associated with the first building, e.g. to a mobile device 13 of the owner or renter of the first building. This message requests approval of this other person for transmitting the security alert to the selected person. The processor 5 may be configured to transmit the security alert to the selected person after the approval has been received from the other person.

In the embodiment of the computer 1 shown in FIG. 2, the computer 1 comprises one processor 5. In an alternative embodiment, the computer 1 comprises multiple processors. The processor 5 of the computer 1 may be a general-purpose processor, e.g. from Intel or AMD, or an application-specific processor. The processor 5 of the computer 1 may run a Windows or Unix-based operating system for example. The storage means 7 may comprise one or more memory units. The storage means 7 may comprise one or more hard disks and/or solid-state memory, for example. The storage means 7 may be used to store an operating system, applications and application data, for example.

The receiver 3 and the transmitter 4 may use one or more wired and/or wireless communication technologies such as Ethernet and/or Wi-Fi (IEEE 802.11) to communicate over the Internet 11, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 3 and the transmitter 4 are combined into a transceiver. The computer 1 may comprise other components typical for a computer such as a power connector. The invention may be implemented using a computer program running on one or more processors.

In the embodiment of FIG. 2, the computer 1 receives data from the detector devices 31-36 via the bridge 23. In an alternative embodiment, the computer 1 receives data from one or more of the detector devices 31-36 without a bridge.

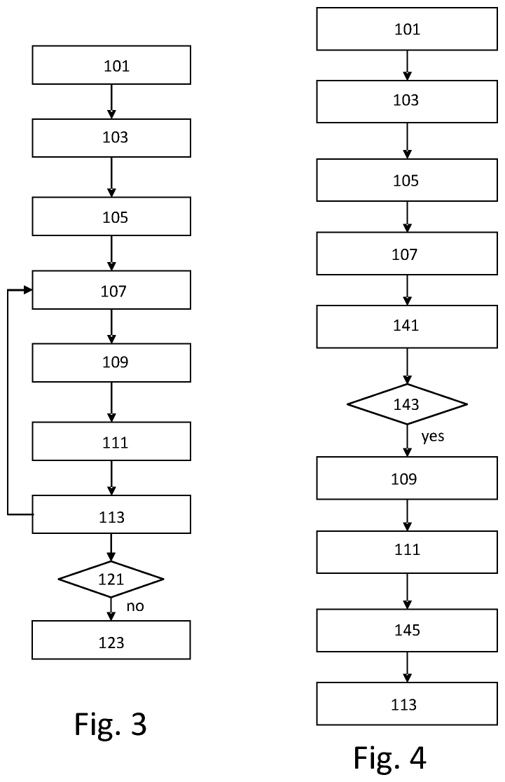

A first embodiment of the method of transmitting a security alert in response to detecting a possible intruder in a first building is shown in FIG. 3. A step 101 comprises obtaining detection data from one or more detector devices. A step 103 comprises detecting the possible intruder in the first building based on the detection data. A step 105 comprises determining a location associated with the possible intruder based on the detection data. A step 107 comprises selecting a person from a plurality of persons by comparing the location associated with the possible intruder with a plurality of locations associated with the plurality of persons.

A step 109 comprises obtaining building information associated with the person. The building information describes a second building. A step 111 comprises determining, based on the building information and the location of the possible intruder, a location in or around the second building from which the possible intruder is expected to be visible. A step 113 comprises transmitting a security alert to the person. The security alert comprises location information indicative of the location in or around the second building and a request requesting the person to look at the first building from the location in or around the second building. Steps 107-113 may be repeated one or more times for one or more further persons.

A step 121 is performed after step 113, at a later time. Step 121 comprises determining whether the detection of the possible intruder detection has been resolved, e.g. whether the police has already been called/dispatched or whether the absence of an intruder has been confirmed. If the detection has not been resolved yet, a step 123 is performed. Step 123 comprises transmitting a further security alert to one of the persons to which the first security alert was transmitted. The further security alert comprises a further request requesting the person to go to the first building.

A second embodiment of the method of transmitting a security alert in response to detecting a possible intruder in a first building is shown in FIG. 4. Step 101 comprises obtaining detection data from one or more detector devices. Step 103 comprises detecting the possible intruder in the first building based on the detection data obtained in step 101. Step 105 comprises determining a location associated with the possible intruder based on the detection data. Step 107 comprises selecting a person from a plurality of persons by comparing the location associated with the possible intruder with a plurality of locations associated with the plurality of persons.

A step 141 comprises transmitting a message to another person, who is associated with the first building, typically the owner/renter of the first building. The message requests approval for transmitting the security alert to the person selected in step 107. This message may or may not identify this person. A step 143 comprise checking whether the approval has been received from this other person. If it is determined in step 143 that this approval has been received, step 109 is performed next.

Step 109 comprises obtaining building information associated with the person selected in step 107. This building information describes a second building. Step 111 comprises determining, based on the building information and the location of the possible intruder, a location in or around the second building from which the possible intruder is expected to be visible.

Next, a step 145 comprises determining a risk level based on the detection data obtained in step 101. For example, step 145 may comprise determining from the detection data whether a door or window was forcefully opened and determining the risk level based on whether the door or window was forcefully opened.

Step 113 comprises transmitting a security alert to the person. The security alert comprises location information indicative of the location in or around the second building and a request requesting the person to look at the first building from the location in or around the second building. In the embodiment of FIG. 4, the security alert further comprises the risk level determined in step 145.

There are various ways to detect security related events. The system preferably knows when users are home or away (either through user input or through geofencing). When users are not at home, a security mode may be activated automatically. During this mode, detection of presence will result in transmission of security alerts. Presence may be detected by motion sensors, door/window sensors, devices with RF-based presence sensing, use of light switches, acoustic sensors, for example.

After detection of the event, characteristics of that event are analyzed. These characteristics may include:
Confidence level
Location of detected event
Time
Contextual Information

Confidence level: Depending on the type of sensor, the confidence level of the detected event might vary. For example, if RF-based sensing is used, the sensor might see a disturbance of the RF signal that could be caused by either an animal or a small human being or the postman approaching the front door from the outside. If the RF sensing event is accompanied by a PIR sensor simultaneously firing/triggering in the same space, the confidence level is increased. At the same time, someone activating the light using a power switch or physical controller gives almost hundred percent confidence that someone is present.

Light may be used to actively increase the confidence level (e.g. switching the lights on with bright light or with a flashing pattern). If an intruder is present in the space, he will normally shun light and will most likely to use the wall switch to manually switch the light again off after the light was “somehow” automatically switched on. This button press event will result in a 100% confidence that a person is present. The confidence levels may also include the freshness of RF sensing baselines (e.g. representing an empty house). A fresher baseline increases the confidence in the RF sensing event detection. If the confidence level is below a certain (e.g. user-configurable) threshold, security alerts are transmitted to one or more other persons (e.g. neighbors) to determine whether the security company or the police needs to be involved.

Location of detected event: The event might be detected in different locations of the house. For example, presence might be detected on the driveway in front of the house. This might be caused by a person passing by the house on the pavement. But the event might also be detected near the door in the back garden, which is not a normal way to approach or enter the home. Similarly, in the house, the presence may be detected in the living room, which for example can be caused by the cleaning person. However, detecting someone in the bedroom would be suspicious if it is not part of the agreement with the cleaning service. In the bedroom, while the cleaning person is present, WiFi-based RF sensing may also be employed to detect unwanted activities and alert the owner and/or renter of the house.

Time: For example, some events might be detected in daytime (with daylight), while others might be detected in the middle of the night.

Contextual Information: Contextual information may be captured at the time of the detected presence. For example, information may be obtained from connected sensors such as a light level sensor (to indicate whether the light in the room was switched on), a microphone (to indicate whether voices were heard in the room), a camera, and/or a temperature sensor (to indicate whether a window is broken or door is open). These could be added as metadata of the presence detection event. Contextual information may also be obtained from WiFi-based sensing, which is known to be capable to detect a human's breathing. 60 GHz WiFi has been shown in labs to be capable to detect heart beats. The breathing or heartbeat of a burglar will be faster due to higher stress than of a normal occupant.

RF-based sensing may also be used to detect rapid acceleration/deceleration of a person or object. For instance, RF-based sensing with 5 GHz WiFi is known to be able to perform fall detection of a person by detecting the −5 g negative acceleration of a person hitting the floor. High-bandwidth WiFi sensing may be performed to detect the rapid acceleration related to the breaking open of a house door with force. In addition, if glass of a window or glass door is broken, the wireless signal propagation pattern within the room and hence the wireless multi-path WiFi CSI will change. This may be determined as the likely break-in point of a burglary.

Upon detecting presence, a security alert is transmitted to one or more persons (e.g. neighbors if the confidence level does not exceed a certain threshold). If neighbors with a view on the room where the possible intruder has been detected are not at home, a security alert may be transmitted to other neighbors, e.g. further down the road. This security alert may comprise a user interface (UI) with visualization that includes information about the rooms/location where presence was detected, the time of the detected presence, the confidence level, contextual information, and historic presence sensing data, for example.

The UI may comprise a floor plan visualization with the relevant presence detection information presented as an overlay at the right location. The overlay can be either 2D or 3D (VR). Possibly, a UI control element (e.g. slider) can be used to scroll through time and show historic/predictive information. This could be used to determine that a burglar, if any, has left the house via the backdoor of the house and the garden-door, for example.

Typically, the visualization is adapted to the characteristics of the recipient of the security alert (e.g. neighbor). These characteristics may include:
Location
Status/availability
Notification device
Type/role of the recipient

Location. The current location of the recipient. This location can be compared to the location of the detected event.

Status/availability. The current status or availability of the recipient is analyzed. For example, if the recipient is not online or in do-not-disturb mode, the notification will be transmitted to another recipient. For instance, if WhatsApp is used for transmitting the security alert, it is checked whether the person has been recently active on his phone.

Notification device. If the notification is presented on a smart watch less information is visualized than when it is presented on a tablet or TV screen.

Type/role of the recipient. The recipient might be assigned a certain role. For example, the primary contact may be given full visibility of all information while secondary contacts may only get a part of this information.

Information represented in the visualization may include:
Risk level of the event
Current state of the security alert response
Confidence score of the crowd-enabled inspection work
Real-time visualization of the crowd responses

Risk level of the event. There may be a difference in the risk level for a neighbor depending on the class of suspected event. The neighbor may be asked to perform an inspection whether, as suspected by the presence sensing system in the garden, there is really an unwanted animal (e.g. a turkey or deer) eating the flowers in the back garden. The ground truth about whether a deer is in the garden may be used by an AI algorithm, for instance, to activate the water sprinkler to drive away the deer.

On the other extreme, the presence sensing system may believe that there is an unidentified human present in the house. Moderate risk levels include the neighbor being asked by the home security system to check the whereabouts of the cleaner or of an elderly person in the house. For instance, a person suffering from dementia is not meant to go to the carpentry workbench room of the house, as he is no longer trusted to operate equipment safely without supervision.

Current state of the security alert response. The event-verification chain of the home security system may include several steps. A first step may involve a visual inspection from only the outside of the house, which is performed for instance by a neighbor with a view on the detection location. The UI presented to the neighbor doing the inspection includes a location from where in his house the neighbor should do the inspection and may, for example, display the likely entry point of the possible intruder in the house or a direction in which the neighbor should look. The UI may also indicate whether the possible intruder is still inside the house or has most likely left the house. Upon the neighbor verifying a broken open door or window, the home security system, as a second step, initiates a call to the police by the neighbor, possibly after a verification step with the owner/renter of the house. In most countries, the police only dispatches officers if a human—rather than a home security system—has confirmed a real burglary.

Upon calling the police, additional details may be displayed on the UI such as the people count of the possible intruders, their motion trail through the building and the suspected current location of the possible intruder. This information might also be shared with the police and visualized on a UI on their systems, e.g. screen in control center, mobile device display, or in-car display.

Confidence score of the crowd-enabled inspection work. A crowd ranking algorithm may evaluate different crowd members to provide a ‘likelihood’ score of correct determination and willingness to respond. Optionally, only a vetted crowd of inspectors may be used for the home monitoring. As more of the verification steps are completed, the displayed confidence level whether there is really an intruder will increase. For instance, the home owner may see in the UI that a first neighbor has already inspected the front door and found nothing unusual, while a second neighbor has agreed to inspect the garden-side house door by looking over his garden fence and the second neighbor thinks that the back door may be open and is right now talking to the police, but the police has not agreed to come.

Real-time visualization of the crowd responses. The UI may display different visualizations of the crowd responses to different neighbors (who are responding), as well as showcasing different details of the planned next steps. For instance, it may be visualized that three neighbors have been alerted with WhatsApp and two of them agreed in the app to look at the house and one of it is right now looking but has not observed anything unusual in the last five minutes.

The UI may also allow a neighbor to accept or decline the next verification step, which the system proposes to him (e.g. is the neighbor willing to directly himself call the police or rather wants a three-way conference call between the owner, the neighbor and the police). The responding neighbor may also link his own home security system to the home security system that has detected the possible intruder. The UI may then display the combined sensing of the two houses, e.g. to establish the movement pattern of the possible intruder in the garden.

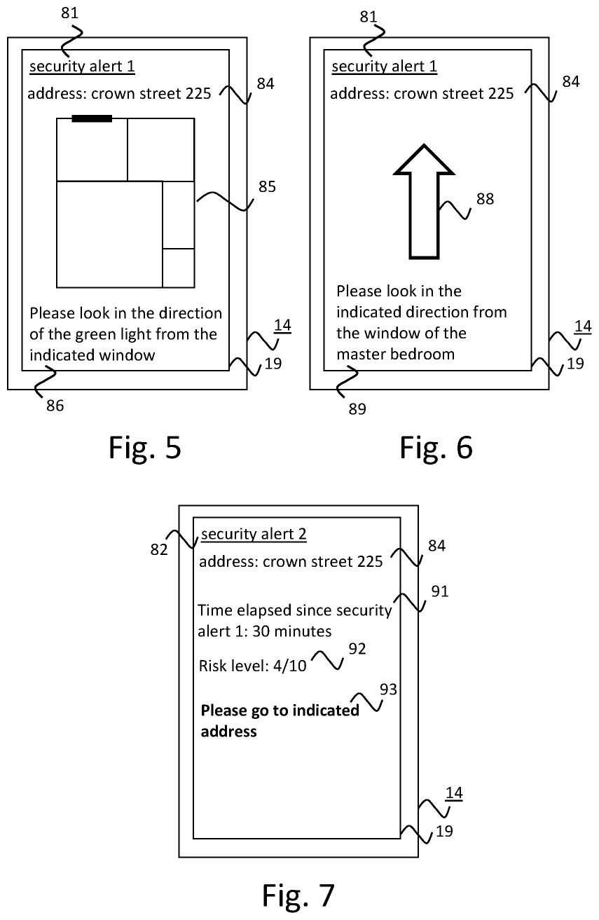

FIG. 5 shows a first example of a displayed security alert. The security alert is displayed on a display 19 of mobile device 14, e.g. by an app running on the mobile device 14. The title 81 (“security alert 1”) indicates that the security alert is the first security alert, transmitted in step 113 of FIG. 3. The address 84 of the first building in which a possible intruder has been detected is shown below the title 81: “crown street 225”. A miniature floorplan 85 indicates the location in the selected person's building from which the possible intruder may be visible and to which he should go. The selected person is the recipient of the security alert.

The miniature floorplan 85 indicates that the person should go to the window of one of his bedrooms. Instructions 86 indicate that the person should please look in the direction of the green light from the indicated window. In the example of FIG. 5, the system selects a lighting device from a plurality of lighting devices based on the location of the potential intruder and controls the lighting device to render a (green) light effect. FIG. 6 shows a second example of a displayed security alert. In the example of FIG. 6, the system does not control a lighting device to render a light effect but determines a direction from the location in or around the second building to the location of the possible intruder and includes this direction in the security alert using direction symbol 88. In the example of FIG. 6, the instructions 89 indicate that the person should please look in the indicated direction from the window of the master bedroom. Instead of, or in addition to, describing with text where the user should go, the miniature floorplan 85 of FIG. 5 might be displayed.

FIG. 7 shows a third example of a displayed security alert. The title 82 (“security alert 2”) indicates that the security alert is the second security alert, transmitted in step 123 of FIG. 3. This second security alert comprises instructions 93 that ask the recipient of the security alert to please go the indicated address. Furthermore, a risk level 92 (“4/10”) is displayed, which the system has determined based on the detection data. This, and the elapsed time indicator 91 (“elapse timed since security alert 1: 30 minutes”) allow the recipient of the second security alert to make a personal assessment on how safe it is to go to the indicated address.

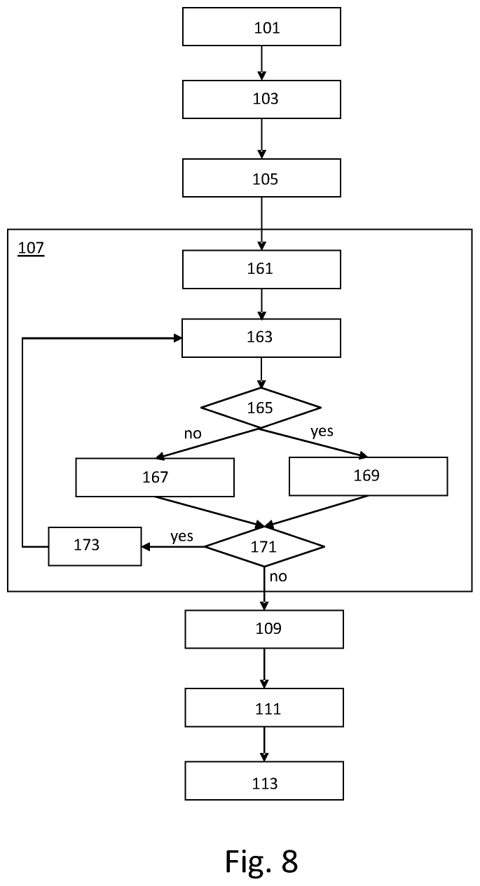

A third embodiment of the method of transmitting a security alert in response to detecting a possible intruder in a first building is shown in FIG. 8. Step 101 comprises obtaining detection data from one or more detector devices. Step 103 comprises detecting the possible intruder in the first building based on the detection data. Step 105 comprises determining a location associated with the possible intruder based on the detection data. Step 107 comprises selecting a person from a plurality of persons by comparing the location associated with the possible intruder with a plurality of locations associated with the plurality of persons.

In the embodiment of FIG. 8, step 107 is implemented by steps 161 to 173. Step 161 comprises selecting persons who, from their own building, have a view on the location of the first building where the possible intruder has been detected. For example, if a possible intruder has been detected in bedroom 63 of house 51 of FIG. 1, then persons 71 and 72 may be selected, and if a possible intruder has been detected in bedroom 64 of house 51, then person 72 may be selected. Step 161 results in a list of selected persons.

Next, a step 163 comprises filtering the list obtained in step 161 to remove persons who have not been determined to be at home. Then, a step 165 comprises determining whether the filtered list obtained in step 163 includes one or more preferred persons. For example, a person who is designated as a friend, is associated with a previous security alert transmitted on behalf of the person, has signed up for receiving security alerts, or is designated as a reliable inspector may be considered to be a preferred person. Furthermore, a person who has been determined to be at home with at most a predetermined number of other persons (e.g. none or one) in the home may be considered to be a preferred person.

If it is determined in step 165 that the filtered list obtained in step 163 includes one or more preferred persons, a step 169 is performed. Otherwise, a step 167 is performed. Step 169 comprises selecting the one or more preferred persons from the filtered list obtained in step 163 by further removing non-preferred persons from the list. Step 167 comprises selecting all persons from the filtered list obtained in step 163. In an alternative embodiment, security alerts are only transmitted to preferred persons and step 167 is omitted.

A step 171 is performed after step 167 or step 169 has been performed. Step 171 comprises checking whether the list obtained in step 167 or step 169 is empty. If not, step 109 is performed next. If it is determined in step 171 that the list is empty, this means that there is currently no person to transmit a security alert to and step 173 is performed next. Step 173 comprises waiting for a while, e.g. waiting for a predetermined period or waiting until someone from the list obtained in step 161 arrives home.

Step 109 comprises obtaining building information associated with the person. The building information describes a second building. Step 111 comprises determining, based on the building information and the location of the possible intruder, a location in or around the second building from which the possible intruder is expected to be visible. Step 113 comprises transmitting a security alert to the person. The security alert comprises location information indicative of the location in or around the second building and a request requesting the person to look at the first building from the location in or around the second building.

The embodiments of FIGS. 3, 4 and 8 differ from each other in multiple aspects, i.e. multiple steps have been added or replaced. In variations on these embodiments, only a subset of these steps is added or replaced and/or one or more steps is omitted. For example, step 145 of FIG. 4 may be omitted from the embodiment of FIG. 4 and/or added to the embodiments of FIGS. 3 and/or 8. The embodiments of FIGS. 3, 4 and 8 may be combined.

The embodiments of FIGS. 3, 4 and 8, and variations thereof, may be extended in one or more of the following manners:
The UI of the security alert (app) may also include a feedback screen to be filled in after the event/alert has been resolved by the owner/renter of the house and/or the neighbor, which can be used for training the AI algorithms. The owner/renter of the house may review the responses of the neighbor and correct them if necessary. For instance, after the neighbor has inspected the backdoor, and burglary was ruled out, he may notice that plants close to the door are moving in heavy wind. This feedback can be used to train the AI of the home security system.
The UI of the security alert (app) may also include a reward element for the person performing the inspection. For instance, a crowd-enabled home security system may provide financial incentives for inspecting a house where a potential intruder has been detected.
The security alerts may be transmitted to the neighbors after the burglar has left the house to minimize the safety risk for the neighbors. An average burglary takes eight minutes according to the FBI. Hence, the primary focus of the home security system may be to scare off the burglar with light effects and determine which rooms are affected by the burglary.
The crowd enabled home security system may pay a context-dependent reward amount for a person, e.g. neighbor, performing the inspection. For instance, at midnight, a higher amount may be paid. If there is scarcity of inspectors, the price of the inspection may be raised. If no one responds to the security alert, the reward may be raised further. The user may be able to, upon receiving a message, adjust the maximum amount paid to the inspector.
The UI of the security alert (app) may include an element where the responding neighbor can trigger an audio effect in the home where the burglar is and tell him that he is now coming over to inspect the house (so that the burglar is leaving more quickly). The audio message may be accompanied by an annoying light effect such as a stroboscopic lighting effect or a very fast flashing effect with changing light color and/or intensity.
The UI of the security alert (app) may also include an element which rates the trustworthiness of the person who has performed the crowd-enabled inspection. It may use a star-rating similar to Uber drivers.
In crowd-enabled home security systems, multiple people may be involved in inspecting one single event. The UI may display the assessment of the several inspectors, attach a confidence level for each inspector and weigh them to determine an overall confidence of the conclusion whether there was really an intruder. The user may be allowed to select a specific inspector or eliminate certain inspectors.
The UI of the security alert (app) may also include a thank-you section enabling the user to thank a neighbor for performing the inspection.
The UI of the security alert (app) may also display home monitoring messages which indicate, for instance, a likely water leakage in the basement and may ask the neighbor to check it out from the outside through the window. The lighting in the basement may be switched on to help the neighbor to see the water. The water leakage may be detected using RF-based sensing by detecting a change in RSSI/wireless multipath signals due to the water on the floor.
The UI of the security alert (app) may enable the inspecting neighbor to take a photo or video, e.g. from his home, and annotate features on the photo or video, e.g. an open door or broken window. A first neighbor may be asked to inspect certain objects which are not in direct field of view of the security camera in the backyard. The UI may allow the first neighbor, who is living to the house to the right, to inspect and annotate objects (e.g. winter garden door is closed; no window broken in kids bedroom) and also highlight objects (e.g. a backdoor of the house) which he is not able to see from his inspecting position. Based on the feedback from the first neighbor that he could not see the backdoor, a second neighbor living on the house to the left may be asked to look over his garden wall and inspect the remaining object. The still remaining-to-be-inspected object may be highlighted by a light effect.
Light effects may be used to walk the inspector step by step though the inspection and annotation process. For example, a first light effect may show a neighbor to inspect the window of the kids' bedroom. Afterwards, the light in the winter-garden may be activated so that neighbor knows he has now to check the window there and report the status in the app. Optionally, a visualization of the house may be used which represents the inspector's current field of view. The light effect in the bedroom may be activated by the end-user pressing on the specific part of the visualization of the house.
In crowd-enabled home security, the UI of the security alert (app) may warn the inspector if the suspected position of the possible intruder gets too close to the inspector. The UI may make sure that the neighbor responding to the alert does not approach the house and if he nevertheless approaches, provide a stern warning about the security risks.
The home security system may visualize to the inspector of the house the current location of the possible intruder by flashing the lights only in the room where the possible intruder is right now. By observing the light effect displayed from the outside of the house, the neighbor knows the possible intruder's position and can keep a safe distance.
The location where the possible intruder has entered the house may be reported in the UI of the security alert (app). For instance, if it is suspected that a burglar has entered through the garden door, the UI may ask during the burglary the inspector to stay at safe distance, but to still try to take a picture or video from the burglar from the safety of his own house when the burglar is leaving the house again through the garden door. After the house is confirmed to be unoccupied, the UI assists the inspector to inspect whether a door or window has really been forcefully opened.

In the embodiments of FIGS. 1 to 8, a person is selected from a plurality of persons, e.g. in step 107 of FIG. 3. In an alternative embodiment, a different type of receiver is selected from a plurality of receivers. For example, a display of a smart home instead may be selected from the plurality of receivers instead of an individual person.

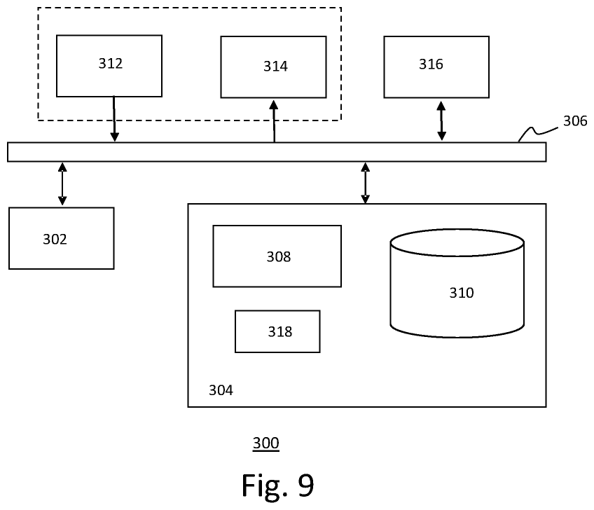

FIG. 9 depicts a block diagram illustrating an exemplary data processing system that may perform the method as described with reference to FIGS. 3, 4, and 8.

As shown in FIG. 9, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 9, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 9) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for transmitting a security alert in response to detecting a possible intruder in a first building, said system comprising:
at least one input interface;
at least one output interface; and
at least one processor configured to:
obtain, via said at least one input interface, detection data from one or more detector devices,
detect said possible intruder in said first building based on said detection data,
determine a location associated with said possible intruder based on said detection data,
select a receiver from a plurality of receivers by comparing said location associated with said possible intruder with a plurality of locations associated with said plurality of receivers,
obtain building information associated with said receiver, said building information describing a second building,
determine, based on said building information and said location of said possible intruder, a location in or around said second building from which said possible intruder is expected to be visible, and
transmit, via said at least one output interface, a security alert to said receiver, to be displayed by said receiver or output via speech by said receiver, said security alert comprising location information indicative of said location in or around said second building and instructions requesting a user of said receiver to look at said first building from said location in or around said second building.

2. A system as claimed in claim 1, wherein said at least one processor is configured to select a lighting device from a plurality of lighting devices based on said location of said potential intruder and control, via said at least one output interface, said lighting device to render a light effect, and wherein said request requests said user of said receiver to look in the direction of said light effect.

3. A system as claimed in claim 1, wherein said at least one processor is configured to determine a direction from said location in or around said second building to said location of said possible intruder and include said direction in said security alert, and wherein said request requests said user of said receiver to look in said direction.

4. A system as claimed in claim 1, wherein said at least one processor is configured to select said receiver from said plurality of receivers based on selecting a receiver of a user which has been determined to be at said second building.

5. A system as claimed in claim 1, wherein said at least one processor is configured to select said receiver from said plurality of receivers based on selecting a receiver of which the user is predetermined to be a friend and/or is associated with a previous security alert transmitted and/or has signed up for receiving security alerts and/or is designated, based on a predetermined analysis, as a reliable inspector.

6. A system as claimed in claim 1, wherein said at least one processor is configured to transmit, via said at least one output interface, a further security alert to said receiver at a later time, said further security alert comprising a further request requesting said user of said receiver to go to said first building.

7. A system as claimed in claim 2, wherein said at least one processor is configured to:
select a further receiver from said plurality of receivers based on said comparison of said location associated with said possible intruder with said plurality of locations associated with said plurality of receivers,
obtain further building information associated with said further receiver, said further building information describing a third building,
determine, based on said further building information and said location of said possible intruder, a location in or around said third building from which said possible intruder is expected to be visible, and
transmit, via said at least one output interface, a further security alert to said further receiver, said further security alert comprising further location information indicative of said location in or around said third building and a further request requesting a user of said further receiver to look at said first building from said location in or around said third building.

8. A system as claimed in claim 1, wherein said at least one processor is configured to determine said location associated with said possible intruder based on a location of at least one of said one or more detector devices.

9. A system as claimed in claim 1, wherein said at least one processor is configured to determine a risk level based on said detection data and include said risk level in said security alert.

10. A system as claimed in claim 9, wherein said at least one processor is configured to determine from said detection data whether a door or window was forcefully opened and determine said risk level based on whether said door or window was forcefully opened.

11. A system as claimed in claim 1, wherein said at least one processor is configured to:
transmit, via said at least one output interface, a message to another receiver, said other receiver being associated with said first building, said message requesting approval for transmitting said security alert to said receiver, and
if said approval has been received from said other receiver, transmit said security alert to said receiver.

12. A system as claimed in claim 1, wherein said at least one processor is configured to select said receiver from said plurality of receivers based on activities currently being performed by users of said plurality of receivers.

13. A method of transmitting a security alert in response to detecting a possible intruder in a first building, said method comprising:
obtaining, by a processor, via a receiver, detection data from one or more detector devices;
detecting, by the processor, said possible intruder in said first building based on said detection data;
determining, by the processor, a location associated with said possible intruder based on said detection data;
selecting, by the processor, a receiver from a plurality of receivers by comparing said location associated with said possible intruder with a plurality of locations associated with said plurality of receivers;
obtaining, by the processor, building information associated with said receiver, said building information describing a second building;
determining by the processor, based on said building information and said location of said possible intruder, a location in or around said second building from which said possible intruder is expected to be visible; and
transmitting, by the processor, via a transmitter, a security alert to said receiver, to be displayed by said receiver or output via speech by said receiver, said security alert comprising location information indicative of said location in or around said second building and a request requesting a user of said receiver to look at said first building from said location in or around said second building.

14. A computer program product for a computing device, and computing device comprising a receiver, a transmitter, and a processing unit, the computer program product comprising computer program code to perform the method of claim 13 when the computer program product is run on the processing unit of the computing device.
